(19) United States
(12) Patent Application Publication
(10) Pub. No.: US 2009/0285972 A1
(43) Pub. Date: Nov. 19, 2009

(54) VALUE WHOLE POULTRY PRODUCT AND METHOD FOR MANUFACTURE

(75) Inventor: Roel Andriessen, Sioux City, IA (US)

Correspondence Address: HUSCH BLACKWELL SANDERS LLP, 190 Carondelet Plaza, Suite 600, ST. LOUIS, MO, 63105, US

(73) Assignee: TYSON FOODS, INC., Springdale, AR (US)

(21) Appl. No.: 12/120,979

(22) Filed: May 15, 2008

(51) Int. Cl. A23L 1/315; A22C 21/00

(52) U.S. Cl. 426/644; 452/160; 452/169

(57) ABSTRACT

An product and method providing for a value whole poultry product meat cut comprising a whole poultry carcass with the breast meat and tenders cut away with the breast skin remaining in tact. The semi-whole bird with the breast and tenders cut away with the breast skin in tact can be netted and/or packaged in a manner to have the look of a whole bird. The semi-whole poultry product can provide all of the normal meat yield to the consumer minus the breast and tender, while enhancing convenience, maintaining the appearance and aesthetic appeal and meeting the potential “per-pound” value of a whole chicken carcass.

### BACKGROUND OF INVENTION

1. Field of Invention:

This invention relates generally to poultry products and, more particularly, to value whole poultry products.

2. Background Art:

There are various methods that relate generally to butchering a poultry carcass into a prepared poultry product or a specific poultry meat cut, and more particularly, to a whole carcass poultry product. There are various poultry products as well as to methods of making and methods of using the poultry products. A butchered product that is more easily cooked and served while maintaining an aesthetically pleasing appearance is always desirable.

In addition to maximizing the aesthetic appeal, and ease of use, it is also desirable to have a poultry product that has certain economic benefits. Consumer tastes have become more sophisticated and the butchering methods must be altered to suit market demand. Consumers are now demanding new and different ways of purchasing and preparing poultry meat products. The demand and the different ways of using and purchasing poultry can also vary by country, which is often driven by individual cultural taste or affordability. In addition, in some regions of the world consumers are not willing to pay a premium for certain cuts of poultry products such as the breast meat or tenders. Whereas, in other markets, consumers are not willing to pay this premium for certain cuts and/or find the lower value cuts more appealing from a cost perspective and also from a taste preference perspective.

For example, there are some regions of the world where consumers have traditionally purchased poultry leg quarters for a less expensive protein alternative or due to personal preference. However, if the leg quarters are sold separate for the whole carcass then it diminishes the possibility of achieving the desired price realization for certain poultry parts once the legs have been separated (for example the back, rib section and the carcass shell). Further, not preserving the whole bird in tact can often reduce the appeal in certain countries. After cooling, a whole bird can have a greater aesthetic appeal and appearance and can form the centerpiece in the presentation of a meal. Whereas, prepared cuts of poultry meat that is partially or wholly separated from the carcass can lose at least some of the aesthetic appeal and reduces the value and marketability of the back and other portions of the carcass. Also, for highly tender meat servings, longer and slower cooking times are generally required with larger cuts of meat. Prepared cuts of poultry meat lose part of this capability as they form smaller cooling portions relative to a full sized and whole bird.

Accordingly, there is a need for a method of using the whole carcass, but provides a value targeted toward certain consumers and markets to increase the potential “per pound” profit of a whole chicken carcass, while also developing new types of chicken products to attract additional consumers. The present invention fulfills such needs by providing a method for cutting the whole chicken carcass, which provides a product, which is a targeted value product, which has sufficient perceived value to be marketed as a separate item.

### BRIEF SUMMARY OF INVENTION

The invention is a produce and method for providing a value whole poultry product meat cut comprising a whole poultry carcass with the breast meat and tenders cut away with the breast skin remaining in tact. The semi-whole bird with the breast and tenders cut away with the breast skin in tact can be netted and/or packaged in a manner to have the look of a whole bird. The semi-whole poultry product can provide all of the normal meat yield to the consumer minus the breast and tender, while enhancing convenience, maintaining the appearance and aesthetic appeal and meeting the potential “per-pound” value of a whole chicken carcass. This is important to private individuals as well as to many food service providers in many.

The costs involved in obtaining, feeding, raising, and bringing to market an edible animal, such as a poultry item continues to rise. Due to the increase in costs and, assuming that only reasonable increases may be made in the market price charged to the consumer for meat products without adversely affecting consumer demand, it has become increasingly important to more skillfully butcher animal carcasses in order to maximize the total meat yield in forms which are more desirable to consumers and, consequently, more profitable for food providers. In addition to maximizing the total meat yield from animal carcasses, consumers are now demanding new and different ways of purchasing and preparing meat products. In addition, consumers are willing to pay a premium for meat products which are interesting and convenient for their needs, such as meat cuts targeted to meat their individual taste preference or their desired value. Poultry products may be sold as either whole carcasses, or as individual parts. There is a ready market for almost all parts of a chicken, particularly in regions of the world like Africa, Central Asia, South East Asia, Middle East and China. The invention provides a value alternative for markets that have traditionally bought leg quarters as a lower cost protein alternative. Thus, there is no need to assume waste associated with poultry carcasses. The invention makes it more feasible to achieve the price realization for certain parts (back and carcass shell) while simultaneously offering the customer with an economical alternative. However, there are still some parts of a whole chicken carcass which are not popular or desirable with the consuming public, particularly when sold as a separate item after for example the breast, tenders, wings and leg quarters have been removed. One such part is the rib cage and back portions, which contain small quantities of meat. This meat is difficult to remove with automated equipment. Thus, these portions can be discarded or used for non-human consumption purposes or ground or comminuted/pulverized after all of the parts have been removed from the rib cage. Though it is not desirable to waste any portion of the meat, due to the breast having the highest commercial value, per pound, of all poultry parts, the breast and other high value parts like the tenders and the wings, can be more valuable if they are sold separately. Therefore the present invention allows for the high value part to be sold as separate items, while maximizing the value of the remaining carcass, whether with or without the wings.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is an illustration of a whole poultry carcass pre-marked for cut;

FIG. 2 is an illustration of a whole poultry carcass with the initial cut of the skin and the skin pulled back exposing the breast;

FIG. 3 is an illustration of a poultry carcass with the breast and tenderloin meat cut away and the breast skin folded back over the removal area;

FIG. 4 is an illustration of an alternative embodiment of a poultry carcass with the breast and tenderloin meat cut away and the breast skin folded back over the removal area and the wings removed;

FIGS. 5A and 5B are an illustration of the aesthetic appearance of the poultry cut; and

FIGS. 6A and 6B are an illustration of an alternative method of pulling the breast skin away and downward.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

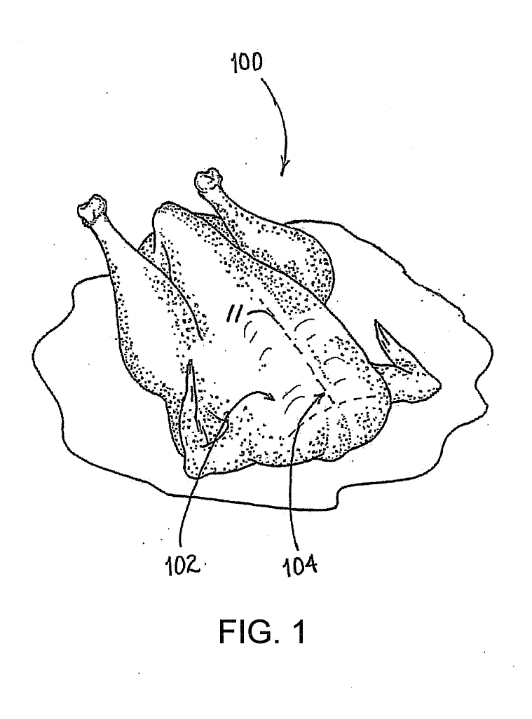

According to the embodiment(s) of the present invention, various views are illustrated in FIG. 1-6 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a value whole poultry product meat cut having a whole poultry carcass with the breast meat and tenders cut away with the breast skin remaining in tack and with or without the wings removed teaches a novel product and method for making the product.

The details of the invention and various embodiments can be better understood by referring to the figures of the drawing. The method comprises the steps of removing left and right breast lobes and ribs and cutting along left and right outer wall surfaces of the keel bone to release and remove the tenders from the keel bone, while leaving the breast skin attached. This process results in a semi-whole poultry cut or product minus the breast and the tenders. By way of illustration, a Whole Chicken Carcass has had its feathers, neck, feet and internal organs removed. The whole chicken can be sold as a product.

The Hind Quarter Or Leg Quarter is the rear portion of the whole chicken carcass including thighs and drumsticks, but not including any significant portion of the chicken breast. Leg quarters can also be sold as a separate product. The Breast Half Of Chicken is the front portion of the whole chicken carcass, including rib cage, keel bone, left and right breast lobes, and a back portion of the chicken. The wings can be considered as part of the breast half, but also can be removed to define a wingless breast half of chicken and the wings can be a separate product. The breast half of chicken also includes a wishbone which may optionally be removed, a portion of the back, which is typically removed and can include a small portion of the chicken neck, which is also typically removed. The Tender Or Tenderloin or fillet strip (tender) is located along either side of the keel bone, adjacent to the breast lobe of the respective side. There are two tenders on each breast of chicken, located underneath respective left and right breast lobes. Each tender is attached along a portion of its surface to the keel bone, and along another portion of its surface to the rib cage. The tender is a natural muscle which may be removed from the breast half as a single piece. There is a natural seam between each breast lobe and tender.

Each of the portions of the carcass may be sold as separate products and is a common practice. The breasts and tenders are the more premium cuts and are often sold separately. However, it is typical to further divide the carcass once the breasts and tenders have been removed to create further separate products, for example, leg quarters. The separation of the parts can be performed manually utilizing a sharp knife, or using a power cutting instrument. However, as outlined in the background, this may prevent realization of the maximum value of the carcass. The present invention, a semi-whole poultry cut minus the breast and tenders, can provide a resolution to this problem. The breast skin can be left in tact. As an alternative embodiment of the present invention, only the breast meat lobes can be cut away and removed while leaving the rib in tact. Yet another embodiment can be cutting away and removing the breast along with the rib as described above, however, leaving the tenders in tact. Various other configurations of the product is within the scope of the present invention including but not limited to cutting away and removing at least one breast and at least one tender.

Referring to FIG. 1, an illustration of a whole poultry carcass pre-marked for cut is shown. A carcass 100 can be initially marked in the breast area 102 as indicated by broken lines 104. The marking can provide a cutting guide for initially making an incision cutting through the skin layer such that the skin can be pulled back to allow access to the breast and tenders while leaving the skin in tact. However, it is noted that in this illustrated embodiment, the breast skin is not completely severed and detached from the carcass. The skin remains in tact every where except for where the incision is made.

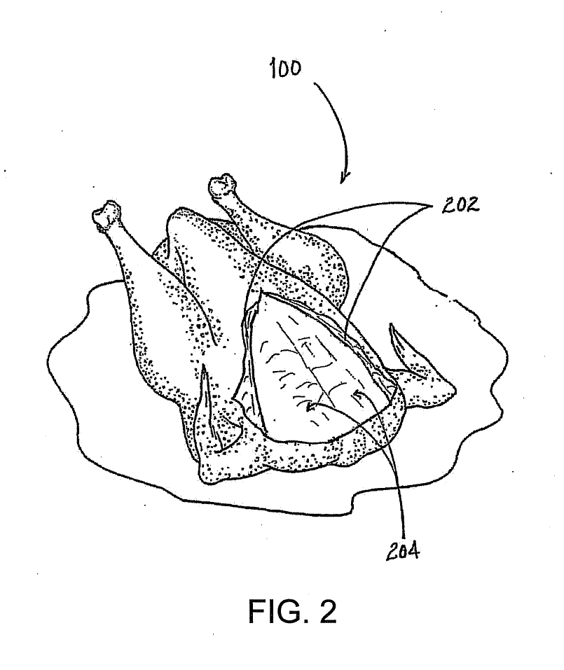

Referring to FIG. 2, an illustration of a whole poultry carcass with the initial cut of the skin and the skin pulled back exposing the breast is shown. The carcass 100, is shown with the skin pulled back 202 after the T-like incision has been made as illustrated in FIG. 1. Other type incisions can be made to accomplish the same task. Once the skin has been pulled back 202, the two breast lobes 204 are exposed for removal. A knife or other cutting means can be used to cut between the left and right breast and into the chest cavity separating the left and right breast rib cages and then cutting between the left and right rib cages and the keel bone to completely separate the breast from the carcass. The tenders can then be separated from the keel bone by cutting along the left and right outer wall surfaces of the keel bone.

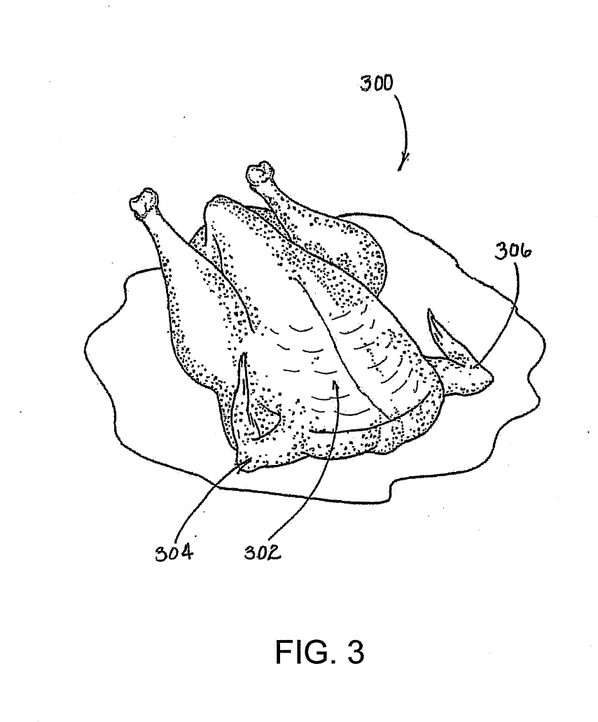

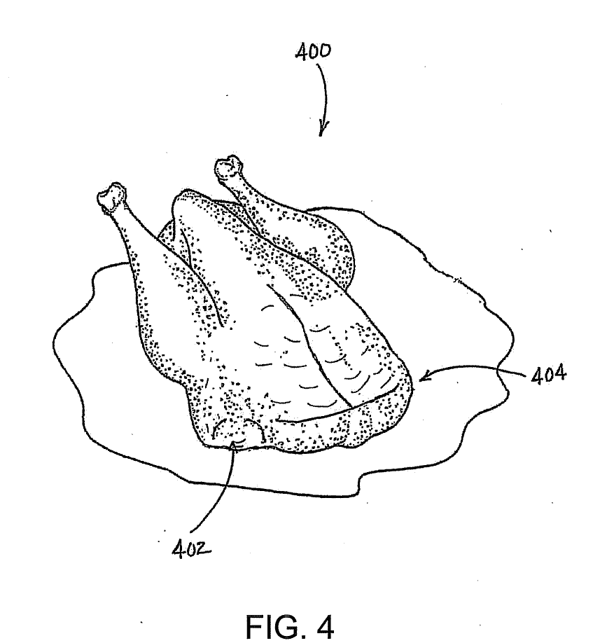

Referring to FIG. 3, an illustration of a poultry carcass with the breast and tenderloin meat cut away and the breast skin folded back over the removal area is shown. Once the semi-whole poultry cut product 300 has been created, the cut breast skin 302 can be draped back over the chest cavity giving the new poultry cut 300 the appearance of a whole carcass. The cut breast skin can be tacked or attached at select locations of the skin to other locations of the skin or to locations on the semi-whole carcass cut in order to hold the skin in place. The wings 306 and 304 can be allowed to remain on the semi-whole carcass or alternatively removed as shown in FIG. 4.

Referring to FIG. 4, an illustration of an alternative embodiment of a poultry carcass with the breast and tenderloin meat cut away and the breast skin folded back over the removal area and the wings removed is shown. Locations 402 and 404 are an illustration of the locations where the wings were removed resulting in an alternative semi-whole carcass 400.

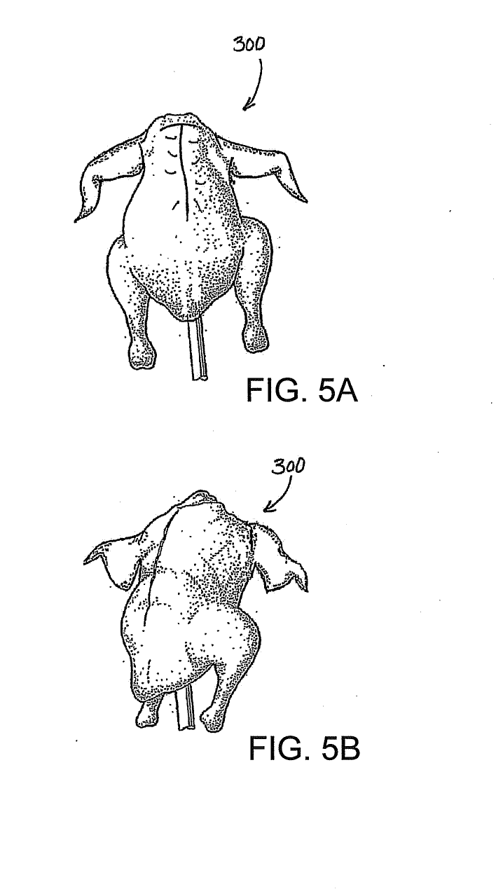

Referring to FIGS. 5A and 5B, an illustration of the aesthetic appearance of the poultry cut is shown. The front and rear views of the semi-whole poultry cut are illustrated to provide an indication of the whole poultry cut appearance.

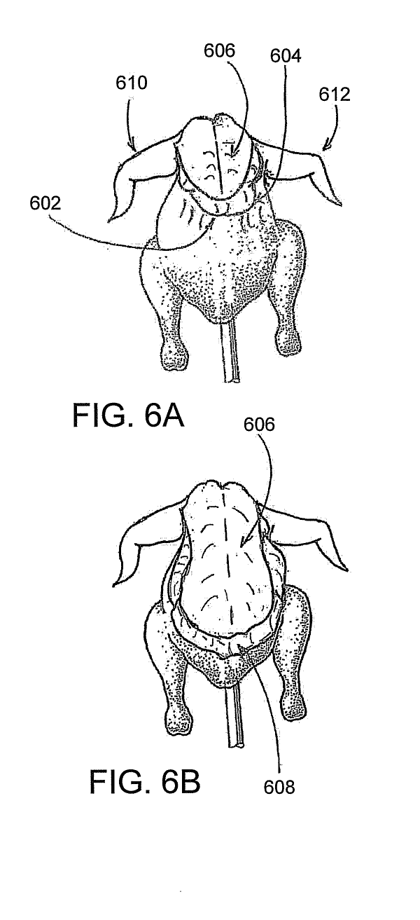

Referring to FIGS. 6A and 6B, an alternative illustration of pulling the breast skin back is shown. Once the head of the carcass has been removed, an edge of skin is exposed. This edge 602 can be grasped by an operator and the skin can be pulled outward away from the carcass thereby separating or pulling away the skin 604 from the breast lobes area 606 and the pulled away skin can be folded down. The skin can be pulled away and downward as indicated by FIGS. 6A and 6B thereby exposing the breast lobes. The skin should pull away easily as only a thin membrane attaches the skin to the meat. However, in order to assist in separating or pulling away the skin an operator can utilize a knife blade or other implement to insert between the breast skin and breast lobe. This alternative, provides for an alternative whole carcass without the incision lines or the need for overlapping the severed sections of skin. Once the skin has been pulled back 608, the two breast lobes 606 are exposed for removal. A knife or other cutting means can be used to cut between the left and right breast and into the chest cavity separating the left and right breast rib cages and then cutting between the left and right rib cages and the keel bone to completely separate the breast from the carcass. The tenders can then be separated from the keel bone by cutting along the left and right outer wall surfaces of the keel bone.

An illustration of a poultry carcass with the breast and tenderloin meat cut away and the breast skin folded back over the removal area is shown, as Referring to FIG. 3, however, in this case there is know incision line. Once the semi-whole poultry cut product 300 has been created, the breast skin 604 can be draped back over the chest cavity giving the new poultry cut 300 the appearance of a whole carcass. The breast skin can be tacked or attached at select locations of the skin to locations on the semi-whole carcass cut in order to hold the skin in place. The wings 610 and 612 can be allowed to remain on the semi-whole carcass or alternatively removed as illustrated in FIG. 4, however, with no incision line in the breast skin.

As illustrated in FIG. 4, an alternative embodiment of a poultry carcass with the breast and tenderloin meat cut away and the breast skin folded back over the removal area and the wings removed is shown, however, with no incision line for this embodiment. Locations 402 and 404 are an illustration of the locations where the wings were removed resulting in an alternative semi-whole carcass 400.

Again, referring to FIGS. 5A and 5B, an illustration of the aesthetic appearance of the poultry cut is shown, however, for this alternative embodiment no incision would be present. The front and rear views of the semi-whole poultry cut are illustrated to provide an indication of the whole poultry cut appearance.

One embodiment of the present invention is a method of creating a semi-whole poultry cut for a value deliverable product comprising the steps of cutting an incision through a breast skin of a poultry carcass and grasping the breast skin along an edge of the incision and pulling the breast skin away from left and right breast meat lobes and exposing the left and right breast meat lobes. The breast skin can be cut away from the breast meat lobe and pulled back. Alternatively the breast skin can be simply grasped along an exposed edge in the neck area and the skin can be pulled outward separating the breast skin from the breast lobes and the breast skin can be pulled downward thereby exposing the breast lobe.

Once the breast lobe is exposed, the carcass can be cut between the left and right breast meat lobes and into a chest cavity separating the left and right breast meat lobes and left and right rib cages. The cut can be made between the breast meat lobes and along the line between the lobes and the cut can have sufficient depth to penetrate the chest cavity. The breast portions can be separated and removed by cutting between each of the left and right rib cages and a keel bone separating and removing left and right breast portions. The tenders can be removed by cutting between each of a left and right outer wall surface of the keel bone and each of left and right tenders respectively separating and removing the left and right tenders. Once the breast portions and the tenders have been removed, the breast skin can be grasped along an edge and the breast skin can be draped over the chest cavity area. The value product can be a semi-whole poultry cut value product comprising an integral butchered poultry carcass having at least one of a breast portion and a tender cut away and removed and having a breast skin of the at least one breast portion draped over a chest cavity where the breast portion and tender has been cut away and/or pulled away and removed and further having a back portion and at least a leg quarter attached to the integral butchered poultry carcass.

The various value whole poultry product meat cut examples shown above illustrate a novel method and product for delivering a targeted value product. A user of the present invention may choose any of the above meat cut embodiments, or an equivalent thereof, depending upon the desired application. In this regard, it is recognized that various forms of the subject value meat cut product could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A method of creating a semi-whole poultry cut for a value deliverable product comprising the steps of:
cutting an incision through a breast skin of a poultry carcass;
grasping the breast skin along an edge of the incision and pulling the breast skin away from left and right breast meat lobes and exposing the left and right breast meat lobes;
cutting between the left and right breast meat lobes and into a chest cavity separating the left and right breast meat lobes and left and right rib cages;
cutting between each of the left and right rib cages and a keel bone separating and removing left and right breast portions;
cutting between each of a left and right outer wall surface of the keel bone and each of left and right tenders respectively separating and removing the left and right tenders; and
grasping the breast skin along the edge and draping the breast skin over the chest cavity.

2. The method for creating a value product as recited in claim 1, further comprising the step of:
cutting away a wing portion of the poultry carcass.

3. The method for creating a value product as recited in claim 1, further comprising the step of:
reattaching the edge of the breast skin to the poultry carcass.

4. A semi-whole poultry cut value product comprising:
an integral butchered poultry carcass having at least one of a breast portion and a tender cut away and removed and having a breast skin of the at least one breast portion draped over a chest cavity where the breast portion and tender has been cut away and removed and further having a back portion and at least a leg quarter attached to the integral butchered poultry carcass.

5. The semi-whole poultry cut as recited in claim 4, having at least one of a left wing portion and a right wing portion cut away and removed.

6. The semi-whole poultry cut as recited in claim 4, where the breast skin of the at least one breast skin portion draped over is attached to the carcass.

7. A semi-whole poultry cut produced by a process comprising the steps of:
providing a poultry carcass;
cutting an incision through a breast skin of the poultry carcass;
grasping the breast skin along an edge of the incision and pulling the breast skin away from left and right breast meat lobes and exposing the left and right breast meat lobes;
cutting between the left and right breast meat lobes and into a chest cavity separating the left and right breast meat lobes and left and right rib cages;
cutting between each of the left and right rib cages and a keel bone separating and removing left and right breast portions;
cutting between each of a left and right outer wall surface of the keel bone and each of left and right tenders respectively separating and removing the left and right tenders; and
grasping the breast skin along an edge and draping the breast skin over the chest cavity.

8. The method for creating a value product as recited in claim 7, further comprising the step of:
cutting away a wing portion of the poultry carcass.

9. The method for creating a value product as recited in claim 7, further comprising the step of:
reattaching the edge of the breast skin to the poultry carcass.

10. A method of creating a semi-whole poultry cut for a value deliverable product comprising the steps of:
grasping a breast skin along an edge proximate a neck area and pulling the breast skin outward away from left and right breast meat lobes and downward exposing the left and right breast meat lobes;
cutting between the left and right breast meat lobes and into a chest cavity separating the left and right breast meat lobes and left and right rib cages;
cutting between each of the left and right rib cages and a keel bone separating and removing left and right breast portions;
cutting between each of a left and right outer wall surface of the keel bone and each of left and right tenders respectively separating and removing the left and right tenders; and
grasping the breast skin along the edge and draping the breast skin over the chest cavity.

11. The method for creating a value product as recited in claim 10, further comprising the step of:
cutting away a wing portion of the poultry carcass.

12. The method for creating a value product as recited in claim 10, further comprising the step of:
reattaching the edge of the breast skin to the poultry carcass.

13. A semi-whole poultry cut produced by a process comprising the steps of:
providing a poultry carcass;
grasping the breast skin along an edge proximate a neck area and pulling the breast skin away from left and right breast meat lobes and exposing the left and right breast meat lobes;
cutting between the left and right breast meat lobes and into a chest cavity separating the left and right breast meat lobes and left and right rib cages;
cutting between each of the left and right rib cages and a keel bone separating and removing left and right breast portions;
cutting between each of a left and right outer wall surface of the keel bone and each of left and right tenders respectively separating and removing the left and right tenders; and
grasping the breast skin along the edge and draping the breast skin over the chest cavity.

14. The method for creating a value product as recited in claim 13, further comprising the step of:
cutting away a wing portion of the poultry carcass.

15. The method for creating a value product as recited in claim 13, further comprising the step of:
reattaching the edge of the breast skin to the poultry carcass.
